(19) United States
(12) Patent Application Publication
(10) Pub. No.: US 2005/0177591 A1
(43) Pub. Date: Aug. 11, 2005

(54) Storage system for managing data with predetermined retention periods

(76) Inventors: Akitsugu Kanda, Yamato (JP); Kenichi Miyata, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/852,223

(22) Filed: May 25, 2004

(30) Foreign Application Priority Data
Feb. 6, 2004 (JP) 2004-030623

(51) Int. Cl. G06F 17/00

(52) U.S. Cl. 707/102

(57) ABSTRACT

Time information from a time server may be incorrect because of human mistakes or cracking. This may cause time errors of one year or more and then data recorded in a storage device might be altered or deleted before their retention periods expire, which would lead to serious troubles. Provided is a storage system including: a plurality of time servers that distribute time information; a time server management device that obtains the time information from the plurality of time servers and selects a most reliable time server; and a file management device that make a decision as to whether a retention period of the data recorded in the storage device ends after the time obtained from the most reliable time server and prohibits alteration and deletion of the data depending on the decision.

### BACKGROUND

The present invention relates to a data management in a storage device, and more particularly to a management of data to be retained for predetermined time periods.

In a computer network including a storage device, a method of synchronizing time among individual devices is suggested in which a representative one of a plurality of terminals connected to a LAN inquires of an NTP (Network Time Protocol) server for time and distributes the obtained time information to the other terminals, whereby the correct time obtained from the NTP server can be distributed to a large number of terminals while suppressing the load on the NTP server (for example, refer to JP 2000-349791 A).

Some data recorded in storage devices, such as medical charts and companies' audit information files, must obligatorily be retained for given periods of time. It is therefore necessary to manage such files so that they will not be altered or deleted before their retention periods expire. For this purpose, a file management method is suggested in which file information to be obligatorily retained for given periods are provided with a WORM (Write Once Read Many) attribute to prohibit alteration and deletion of the files during those periods (for example, refer to “SnapLock™ Compliance Software and SnapLock Enterprise Software”, Network Appliance, Inc., Internet URL<http://www-jp.netapp.com/products/filer/snaplock.html>). This method can certainly protect files during their retention periods. Files can be altered or deleted after their retention periods have expired.

### SUMMARY

In such file management using WORM attribute assigned to files, if the clock in the device is incorrect, the files may possibly be altered or deleted before their retention periods end, but it is possible to properly manage the files when correct time information obtained from an NTP server is used.

However, in reality, time information from the NTP server may be incorrect because of human mistakes or cracking. This may cause time errors of one year or more and then files might be altered or deleted before their retention periods expire, which would lead to serious troubles.

According to the present invention, there is provided a storage system, comprising: a plurality of time servers that distribute time information; a file management device that manages a retention period of data stored in a storage device; and a time server management device that obtains the time information from the time servers, the time server management device comprising: a client part that obtains the time information from the plurality of time servers; a time detachment inspection part that makes a comparison between the plurality of time information obtained from the time servers and given reference time information; a priority setting control part that changes priorities of the time servers based on a result of the comparison made by the time detachment inspection part; and a clock control part that obtains the time information from the time server having a highest priority, and notifies the file management device of the obtained time information, the file management device comprising: a second internal clock; a file managing database in which the retention period of the data recorded in the storage device is stored; and a file control part that corrects time information of the second internal clock based on the time information sent from the time server management device, refers to the file managing database to make a decision as to whether the retention period of the data recorded in the storage device ends after corrected time of the second internal clock, and prohibits alteration and deletion of the data depending on the decision.

According to the present invention, it is possible to manage a WORM attribute constantly on the basis of correct time so as to properly manage files that must be retained for given time periods.

### BRIEF DESCRIPTION OF THE DRAWINGS

FIG. 1 is a block diagram of a storage system according to a first embodiment of the present invention.

FIG. 2 is a block diagram of an NTP server management device.

FIG. 3 is an explanatory diagram showing data recorded in a setting parameter DB.

FIG. 4 is an explanatory diagram showing data recorded in a time managing DB.

FIG. 5 is a time chart of processing performed by devices and programs at a detachment check time.

FIG. 6 is a flowchart of a process performed by a time detachment inspection program.

FIG. 7 is an explanatory diagram showing how a clock halt/priority setting program changes priorities order in the time managing DB.

FIG. 8 is an explanatory diagram showing a display screen of a management terminal.

FIG. 9 is a block diagram of a WORM management device and a storage device.

FIG. 10 is an explanatory diagram showing an example of data recorded in a WORM managing DB.

FIG. 11 is a block diagram of a storage system according to a second embodiment of the present invention.

### DESCRIPTION OF THE PREFERRED EMBODIMENTS

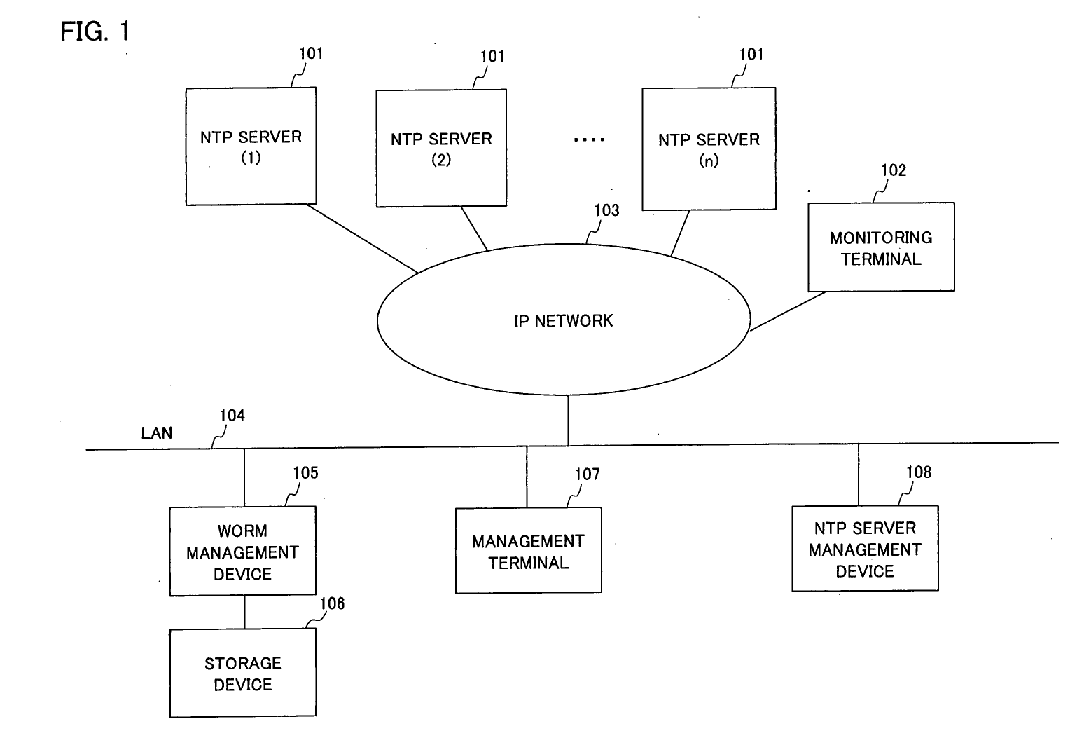

FIG. 1 is a block diagram of a storage system according to a first embodiment of the present invention.

NTP servers 101 are computer devices each having a CPU, a memory, and an interface. The NTP servers 101 store correct time information and distribute the information to other terminals and other NTP servers via the NTP (Network Time Protocol) protocol. The NTP servers 101 are hierarchically connected to other NTP servers (not shown) and refer to an upper-level NTP server having highly accurate time information obtained by an atomic clock, a GPS receiver, or the like to thereby correct their own time information. Also, the NTP servers 101 are connected to other terminals through an IP network 103 and provide their own time information in response to requests from an NTP server management device 108.

A monitoring terminal 102 is a computer device having a CPU, a memory, and an interface, on which a program for receiving operating conditions of the NTP servers 101 from the NTP server management device 108 is operating. The monitoring terminal 102 thus receives from the NTP server management device 108 a notification that some NTP server 101 has a trouble.

A WORM management device 105 is a computer device having a CPU, a memory, and an interface and is connected to a storage device 106. In the WORM management device 105, a program for managing the retention periods of files stored in the storage device 106 is operating. The WORM management device 105 is connected also to a LAN (Local Area Network) 104 and determines, according to that management program, whether or not to allow other terminals (not shown) connected to the LAN 104 to alter or delete the files.

The storage device 106 is formed of, e.g. a disk array device, to and from which other terminals (not shown) connected to the LAN 104 write or read files.

A management terminal 107 is a computer device having a CPU, a memory, and an interface, on which a program for setting, for example, which NTP servers 101 are to be referred to by the NTP server management device 108 is operating. The management terminal 107 is connected to the LAN 104. More specifically, when an administrator enters information for settings, such as IP addresses of NTP servers to be referred to by the NTP server management device 108 and times to perform the reference, then the management terminal 107 sets the information in the NTP server management device 108.

As will be described later, the NTP server management device 108 is a computer device having a CPU, a memory, an interface, and a storage device, on which a program for obtaining time information from the NTP servers 101 is operating. The NTP server management device 108 is connected to the LAN 104. More specifically, the NTP server management device 108 obtains time information from a plurality of NTP servers 101 at a given time (detachment check time) and selects a most reliable NTP server 101, while detecting an NTP server 101 having a problem to notify the monitoring terminal 102 of the NTP server 101. Also, with given timing, the time information is obtained from the most reliable NTP server 101 and sent to the WORM management device 105.

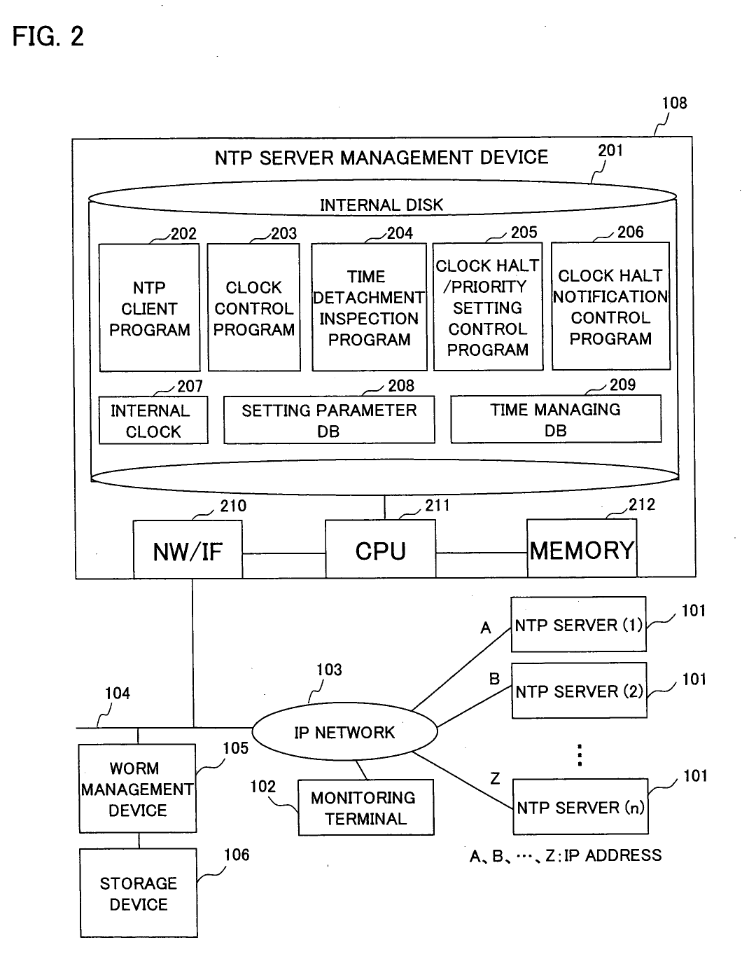

FIG. 2 is a block diagram of the NTP server management device 108 of the first embodiment of the present invention.

The NTP server management device 108 includes a CPU 211, a memory 212, a network interface (NW/IF) 210, and an internal disk 201. The internal disk 201 is connected to the CPU 211 and contains various programs, data, etc., as will be described later.

The CPU 211 executes the programs recorded in the internal disk 201.

The network interface (NW/IF) 210 is connected to the CPU 211. The network interface (NW/IF) 210 is connected also to the LAN 104 and conducts communication between the NTP server management device 108 and terminals connected to the LAN 104 or to the IP network 103. For example, the time information recorded in an internal clock 207 is sent to the WORM terminal 105 through the network interface (NW/IF) 210.

The memory 212 connected to the CPU 211 is used, as needed, to record copies of various programs etc. recorded in the internal disk 201 and data used when the CPU 211 executes these programs.

Next, the programs etc. recorded in the internal disk 201 will be described.

An NTP client program 202 obtains time information from a plurality of NTP servers 101 at a detachment check time and records the time information in a time managing DB (database) 209. The contents of the time managing DB 209 will be described in detail later.

A clock control program 203 obtains, with given timing, the time information from an NTP server 101 having the highest priority (i.e. an NTP server 101 determined to be most reliable) and records the time information in the internal clock 207. While this given timing is determined according to the specifications of an OS (operating system) and the like, the timing can generally be set at given time intervals of several minutes.

A time detachment inspection program 204 makes a comparison of the pieces of time information recorded in the time managing DB 209 to see whether or not a detachment equal to or more than a given threshold exists (detachment check). The procedure of the detachment check will be described in detail later.

A clock halt/priority setting control program 205 halts communication with NTP server(s) 101 having a problem. For example, when the detachment check shows that an NTP server 101 offered time information with a detachment equal to or more than the given threshold, or when an NTP server 101 did not respond when the NTP client program 202 tried to obtain time information, then the clock halt/priority setting control program 205 decides that a problem exists in the NTP server 101. The priority of the defective NTP server 101 is then changed to the lowest rank in the time managing DB 209. The changing procedure will be described in detail later.

A clock halt notification control program 206 notifies the monitoring terminal 102 that the clock halt/priority setting control program 205 has halted communication with one or more NTP servers 101.

The time information that the clock control program 203 obtains from the highest-priority NTP server 101 is recorded in the internal clock 207. This time is sent to the WORM management terminal 105. The initial value of the internal clock 207 may be manually set by the system administrator.

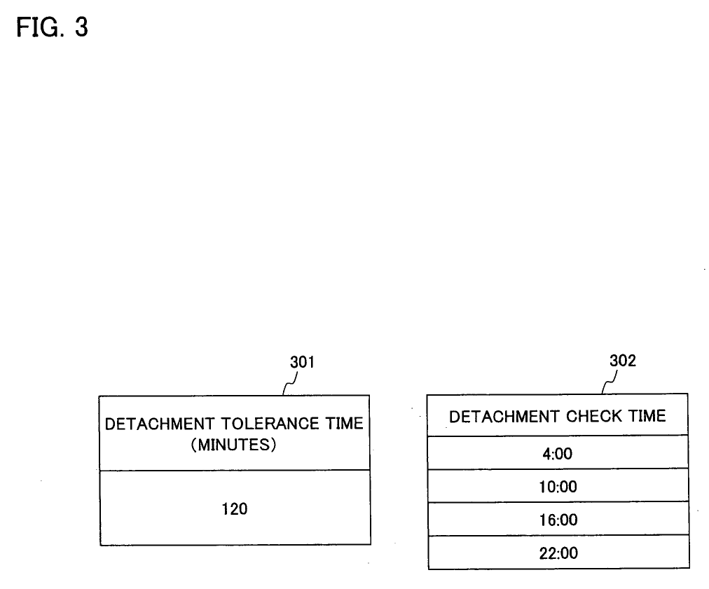

As will be explained referring to FIG. 3, a setting parameter DB (database) 208 records times at which the NTP client program 202 obtains time information from the NTP servers 101 and at which the time detachment inspection program 204 performs a detachment check about the time information, and also records a threshold used for the detachment check.

The time managing DB 209 records the time information that the NTP client program 202 regularly obtains from the plurality of NTP servers 101.

FIG. 3 is an explanatory diagram showing data recorded in the setting parameter DB 208.

A detachment tolerance time 301 is a threshold used by the time detachment inspection program 204 during the detachment check. Time information obtained from each NTP server 101 is compared with a reference time. When the difference is larger than the detachment tolerance time 301, it is determined that a problem exists in the NTP server 101 that offered that piece of time information, and then the clock halt/priority setting control program 205 and the clock halt notification control program 206 operate. In the example of FIG. 3, when any NTP server 101 offered time information having a time difference of 120 minutes or more, a decision is made that this NTP server 101 has a problem. For example, the reference time may be the mean value of time information from all NTP servers 101, or may be the time that the internal clock 207 shows at the time of the detachment check.

The detachment check time 302 indicates times to perform a series of check processing, i.e. times at which the NTP client program 202 obtains time information from the plurality of NTP servers 101 and a detachment check is conducted about the time information. In the example of FIG. 3, the processing is performed at 4:00, 10:00, 16:00, and 22:00 every day.

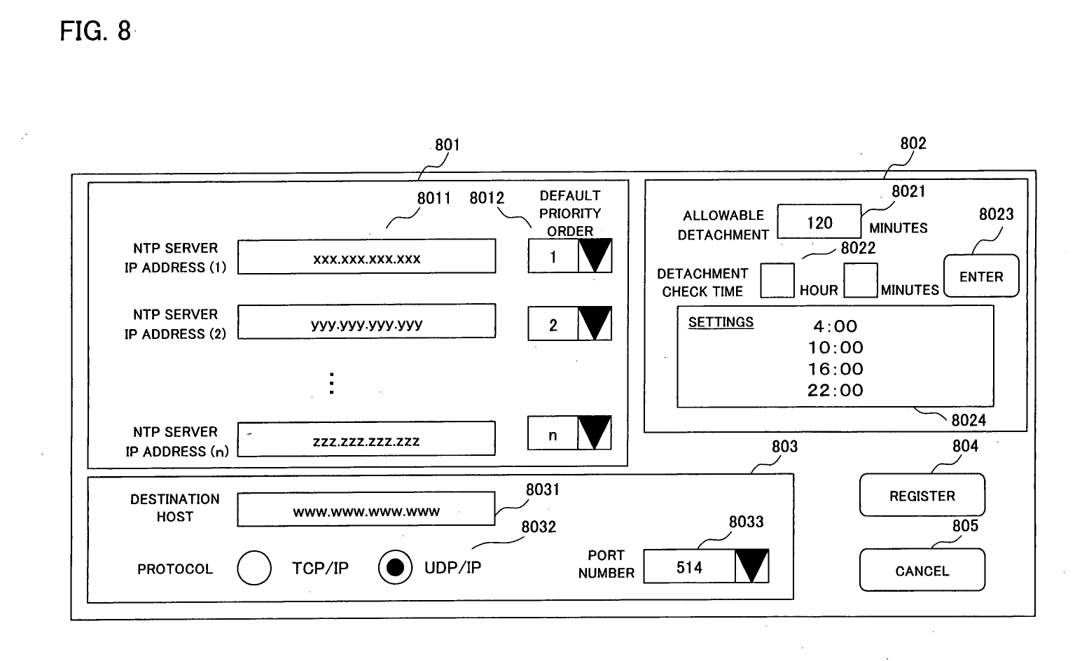

The detachment tolerance time 301 and the detachment check time 302 are set by the system administrator (see FIG. 8).

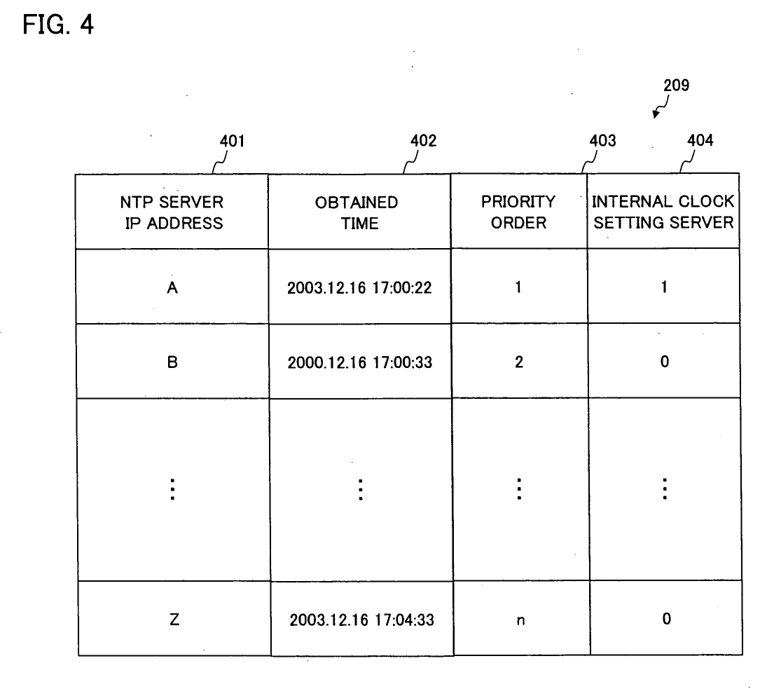

FIG. 4 is an explanatory diagram showing data recorded in the time managing DB 209.

In FIG. 4, NTP server IP addresses 401 indicate IP addresses of a plurality of NTP servers 101 from which the NTP server management device 108 obtains time information. Instead of the IP addresses, any other identification codes uniquely assigned in the network can be used.

Obtained times 402 indicate the time information that the NTP client program 202 has obtained from the individual NTP servers 101, which are updated every time the information is obtained at a detachment check time.

Priorities 403 indicate priority ranks assigned to the individual NTP servers 101, where a higher priority 403 indicates a higher reliability. The initial values of the priority 403 are set by the system administrator (see FIG. 8) and changed by the clock halt/priority setting control program 205 afterward.

An internal clock setting server 404 indicates a flag that shows from which NTP server 101 the time information should be sent to the WORM management terminal 105. The flag is set to “1” only for the NTP server 101 ranked first in the priority order 403 and set to “0” for the remaining NTP servers 101, where the time information from the NTP server 101 with a flag of “1” is sent to the WORM management terminal 105. That is, the flag “1” is always assigned to only one server selected from the NTP servers 101 and the selected NTP server 101 sends the time information to the WORM management terminal 105. In the example of FIG. 4, the time information obtained from the NTP server 101 whose NTP server IP address 401 is “A” is sent to the WORM management terminal 105.

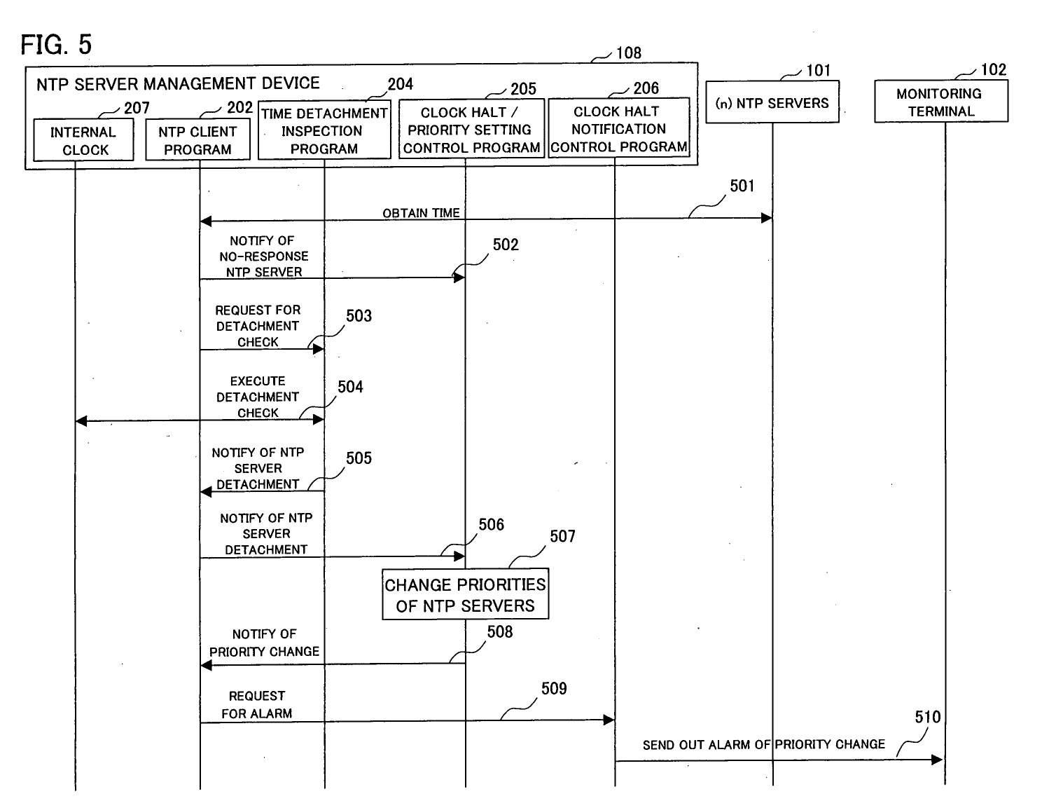

FIG. 5 is a time chart of the processing performed by the devices and programs at a detachment check time.

First, the NTP client program 202 obtains time information from a plurality of NTP servers 101 and records the time information in the time managing DB 209 (501). When any of the NTP servers 101 does not respond, the time halt/priority setting control program 205 is notified of the NTP server 101 (502).

Next, the NTP client program 202 instructs the time detachment inspection program 204 to perform a detachment check (503). In response to this instruction 503, the time detachment inspection program 204 compares the time information from the individual NTP servers 101 with a reference time (504). Herein, by way of example, the time recorded in the internal clock 207 is used as the reference.

When the results of the comparison 504 show that some NTP server 101 has a difference larger than the detachment tolerance time 301, the NTP client program 202 is notified of the NTP server 101 (505). The NTP client program 202 sends this notification 505 further to the clock halt/priority setting control program 205 (506).

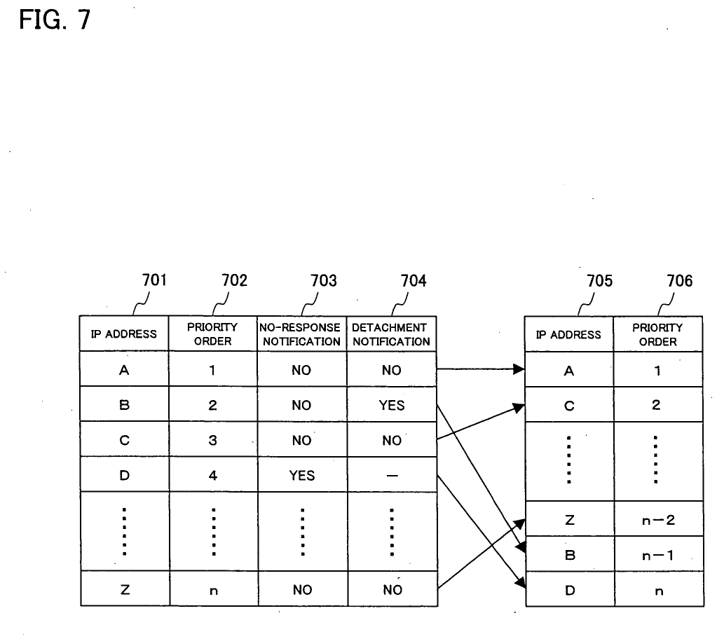

The clock halt/priority setting control program 205 decides that the NTP servers 101 indicated by the notifications 502 and 506 have some troubles and lowers their priorities 403 in the time managing DB 209 (507). When a problem exists in the NTP server 101 ranked first in priority, then the NTP server 101 ranked second is set at the first rank. This processing will be described later referring to FIG. 7. Then, the NTP client program 202 is notified that the priorities 403 have been changed (508).

Receiving this notification 508, the NTP client program 202 requests the clock halt notification control program 206 to send out an alarm (509). The clock halt notification control program 206 receives this request 509 and sends out an alarm to the monitoring terminal 102 to show that the priorities 403 of the NTP servers 101 have been changed (510).

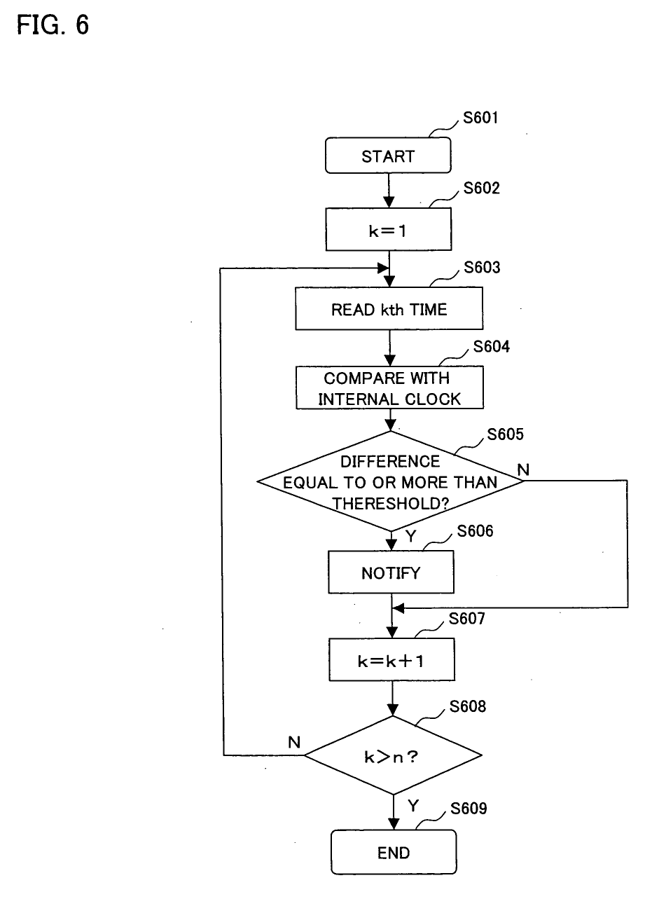

FIG. 6 is a flowchart of the processing performed by the time detachment inspection program 204 in 504 and 505 of FIG. 5.

Now, “n” indicates the number of NTP servers 101 from which the NTP client program 202 obtains time information. Also, “k” indicates a value of a counter that the time detachment inspection program 204 uses to count the NTP server priorities 403, varying in the range from 1 to n.

When starting the detachment check (S601), the time detachment inspection program 204 initially sets the counter value k to “1” (S602). Next, referring to the time managing DB 209, the obtained time 402 is read from the NTP server ranked kth in the priority order 403 (S603).

Next, the time is compared with a reference time (S604). In the example of FIG. 6, the time recorded in the internal clock 207 is used as the reference. When the difference between the two exceeds a given threshold (the detachment tolerance time 301 recorded in the setting parameter DB 208) as a result of the comparison (S605), then it notifies the NTP client program 202 of it (S606) and increments the counter value k by one (S607). On the other hand, when the difference does not exceed the given threshold (S605), the counter value k increments by “1” (S607) without notification.

Next, it is checked whether or not the counter value k has exceeded the number n of NTP servers 101 from which time information is to be obtained. When k exceeds n, the detachment check to all NTP servers 101 is complete and the process ends (S609). On the other hand, when k does not exceed n, the flow returns to Step S603 to read the obtained time 402 from the NTP server 101 having a kth priority 403 and proceeds with the subsequent steps.

FIG. 7 is an explanatory diagram showing how the clock halt/priority setting control program 205 changes the priorities 403 in the time managing DB 209. This procedure is performed in 507 of FIG. 5.

First, the clock halt/priority setting control program 205 refers to the IP addresses 401 and the priorities 403 in the time managing DB 209. An example of the results of the reference is shown in the columns of IP addresses 701 and priority orders 702.

Next, when some NTP server 101 did not respond or when the detachment check shows that some NTP server 101 has a detachment equal to or more than the given threshold (the detachment tolerance time 301), the clock halt/priority setting control program 205 determines that the NTP server 101 has a problem.

Specifically, the clock halt/priority setting control program 205 records the notification indicating no-response from NTP servers 101 (502 of FIG. 5) and the notification indicating time detachment (506 of FIG. 5). The column of no-response notifications 703 shows for each NTP server 101 whether or not a notification was given in 502 of FIG. 5. In the example of FIG. 7, the notification was made about the NTP server 101 having an IP address of “D”. The column of detachment notifications 704 shows whether or not a notification was given in 506 of FIG. 5. In the example of FIG. 7, the notification was made about the NTP server 101 having an IP address of “B”. Therefore the clock halt/priority setting program 205 determines that the NTP servers 101 with the IP addresses of “B” and “D” have problems.

Next, the clock halt/priority setting control program 205 changes the priority 702 of a defective NTP server 101 to the lowest (nth) priority. However, it should be noted that, when there are a plurality of NTP servers 101 whose priorities 702 are to be set to the lowest priority, a new priorities are determined on the basis of the priorities 702 set before the detachment check. The remaining NTP servers 101 are sequentially moved up in the priorities 702.

The columns of IP addresses 705 and priorities 706 respectively show the IP addresses and the priority order of the NTP servers 101 whose priorities have been changed. In the example of FIG. 7, two NTP servers 101 in “B” and “D” have problems, so that the NTP server 101 in “D”, ranked lower in the priorities 702 before the change, is set at the lowest (nth) priority 706 and the NTP server 101 in “B” is set at the (n−1)th priority 706.

Alternatively, NTP servers 101 about which no-response notification 703 or detachment notification 704 was made may be removed from the time managing DB 209 so as not to obtain time information therefrom afterward.

FIG. 8 is an explanatory diagram showing the display screen of the management terminal 107.

For greater convenience, the example of FIG. 8 adopts a graphical user interface (GUI) that allows selections through pointing and clicking with a mouse cursor, as well as through typing with a keyboard.

In FIG. 8, an NTP server registration box 801 is used when the system administrator registers NTP servers 101 from which time information is to be obtained. The system administrator can set NTP servers 101 from which time information is to be obtained by entering their IP addresses in NTP server IP address boxes 8011. Also, the system administrator can set the priorities of the NTP servers 101 at the beginning of system operation by entering priorities in default priority boxes 8012.

The inverted triangles on the right of the default priority boxes 8012 show that, for greater convenience, a pull-down menu can be used for entering a priority in each box. More specifically, when this inverted triangle figure is clicked, a menu of numerical values available as default priorities appears and allows the system administrator to select any value from the menu.

A detachment check setting box 802 is used when the system administrator sets conditions for the time detachment check of the NTP servers 101. The system administrator can set the detachment check threshold (the detachment tolerance time 301) by inputting a time in an allowable detachment box 8021. It is set as 120 minutes in the example of FIG. 8. Also, the system administrator can set the detachment check time 302 by inputting a time in a detachment check time box 8022. When an enter button 8023 is clicked after the inputting, the inputted time is registered and displayed in a setting display box 8024.

A notification setting box 803 is used when the system administrator sets a destination of, e.g. an alarm. The system administrator can set a host (terminal) as the destination by entering an IP address in a destination host setting box 8031. Also, the system administrator can select a protocol for the notification by clicking a circle beside each protocol name in protocol selecting buttons 8032. FIG. 8 shows an example in which UDP/IP is selected. While the example of FIG. 8 limits the selectable protocols to TCP/IP and UDP/IP, other protocols may be offered for selection. A port number can be inputted to a port number selecting box 8033 to set the port number of the destination host (terminal). A pull-down menu may be applied here again to enhance the convenience.

After filling these boxes, the system administrator clicks a registration button 804 to register the inputted contents and after that the system runs according to the contents. The inputted contents can be canceled by clicking a cancel button 805 and then the system administrator can enter information again.

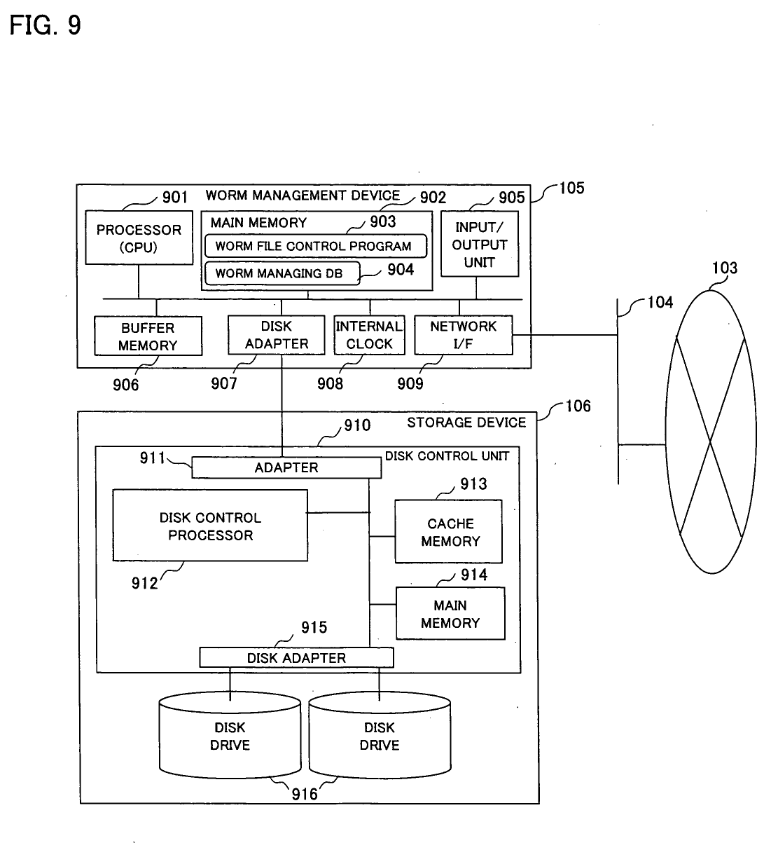

FIG. 9 is a block diagram of the WORM management device 105 and the storage device 106.

The WORM management device 105 includes a processor (CPU) 901, a main memory 902, an input/output unit 905, a buffer memory 906, a disk adapter 907, an internal clock 908, and a network interface (I/F) 909.

The processor 901 executes a WORM file control program 903 recorded in the main memory 902 to manage a WORM managing DB (database) 904, and processes data write/read requests to the storage device 106 from other terminals (not shown) connected to the LAN 104 and decides whether or not to allow these terminals to alter or delete files recorded in the storage device 106.

The main memory 902 contains the WORM file control program 903 and the WORM managing DB 904.

The WORM file control program 903 refers to the internal clock 908 and the WORM managing database 904 and changes the WORM attribute to “0” when a file retention end time expires.

During management of the WORM management device 105 by the system administrator, the input/output unit 905 accepts inputs, e.g. commands, from the system administrator and also displays the current condition and the results of input.

The buffer memory 906 is used to temporarily record data written in disk drives 916 and data read from the disk drives 916.

The disk adapter 907 is an interface that arbitrates data being exchanged between the WORM management device 105 and the storage device 106. The disk adapter 907 conforms to a standard like Fibre Channel (FC) or SCSI, for example.

The internal clock 908 is capable of independently measuring time without receiving a clock signal from the outside of the WORM management device 105. The processor 901 corrects the time of the internal clock 908 according to time information obtained from the NTP server management device 108.

The network I/F 909 is an interface used to connect the WORM management device 105 to the LAN 104 to allow communication with other terminals (not shown) connected to the LAN 104.

The storage device 106 includes one or more disk drives 916 that record data sent from other terminals (not shown) and a disk control unit 910 that controls data write/read to and from the disk drives 916.

The disk control unit 910 includes an adapter 911, a disk control processor 912, a cache memory 913, a main memory 914, and a disk adapter 915.

The adapter 911 is an interface that arbitrates data being exchanged between the WORM management device 105 and the storage device 106. The adapter 911 conforms to a standard like Fibre Channel (FC) or SCSI, for example.

The disk control processor 912 controls individual portions of the disk control unit 910 to process data write/read to and from the disk drives 916.

The cache memory 913 is used to temporarily record data to be written to the disk drives 916 and data read from the disk drives 916.

The main memory 914 records programs executed by the disk control processor 912, data required for the execution, and the like.

The disk adapter 915 is an interface that arbitrates data being exchanged between the disk control unit 910 and the disk drives 916. The disk adapter 915 conforms to a standard like Fibre Channel (FC) or SCSI, for example.

Alternatively, the WORM file control program 903 and the WORM managing DB 904 may be recorded in the main memory 914 of the disk control unit 910, and the disk control processor 912 may execute the WORM file control program 903.

Also, the disk control unit 910 may include the network I/F 909 and be connected to the LAN 104.

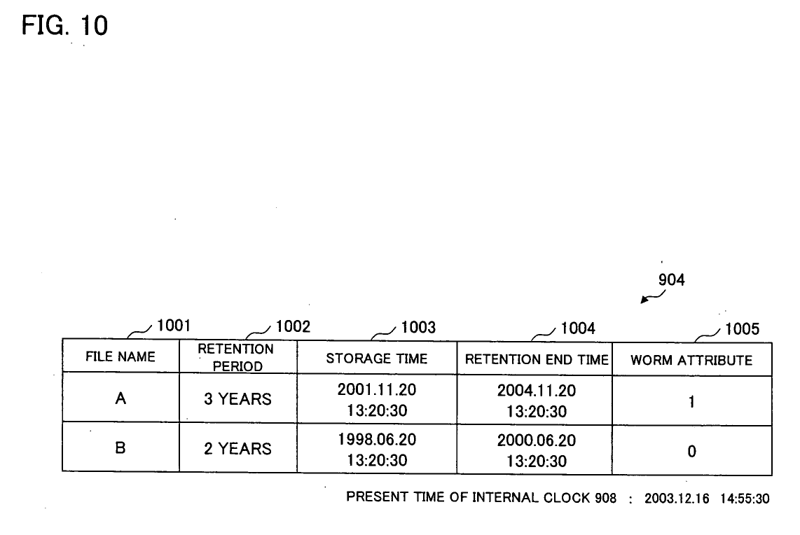

FIG. 10 is an explanatory diagram showing an example of data recorded in the WORM managing DB 904.

In FIG. 10, the data is managed on a file basis. The column of file names 1001 includes names of the files recorded in the storage device 106. In the example of FIG. 10, a file A and a file B are recorded in the storage device 106.

The column of retention periods 1002 includes periods for which the files should be retained, where a retention period is defined for each file. After the files are recorded in the storage device 106, the files cannot be altered or deleted until their respective retention periods 1002 expire. In the example of FIG. 10, the retention period 1002 of the file A is three years and the retention period 1002 of the file B is two years.

The column of storage times 1003 includes times at which individual files are recorded in the storage device 106. In the example of FIG. 10, the storage time 1003 of the file A is 13:20:30 on Nov. 20, 2001 and the storage time 1003 of the file B is 13:20:30 on Jun. 20, 1998.

The column of retention end times 1004 includes times at which the retention periods 1002 expire since the storage times 1003 of the respective files, which show when the file retention periods 102 end. That is, the files cannot be altered or deleted before the retention end times 1004. In the example of FIG. 10, the retention end time 1004 of the file A is 13:20:30 on Nov. 20, 2004 and the retention end time 1004 of the file B is 13:20:30 on Jun. 20, 2000.

The column of WORM attributes 1005 is an attribute that is assigned to files whose retention end times 1004 have not expired yet, and therefore files having the WORM attribute 1005 of “1”, or files provided with this attribute, cannot be altered or deleted. On the other hand, assigning “0” to a file means that this attribute is not attached to the file. More specifically, this attribute is set at “0” when the retention end time 1004 of a file is earlier than the present time shown by the internal clock 908, and set at “1” when the retention end time 1004 of a file is later than the present time. In the example of FIG. 10, the internal clock 908 indicates the present time being Dec. 16, 2003, so that the WORM attribute 1005 of the file A is “1” and the WORM attribute 1005 of the file B is “0”. That is, the WORM file control program 903 allows other terminals (not shown) connected to the LAN 104 to alter or delete the file B but prohibits them from altering or deleting the file A.

As explained so far, according to the first embodiment of the present invention, the storage system regularly makes a comparison of time information obtained from a plurality of NTP servers 101, excludes NTP servers 101 having significant time detachments, selects an NTP server 101 likely to be the most reliable, and obtains time information from that NTP server 101. This enables the WORM attribute 1005 to be managed constantly with correct time and prevents alteration and deletion of files that should not be altered or deleted.

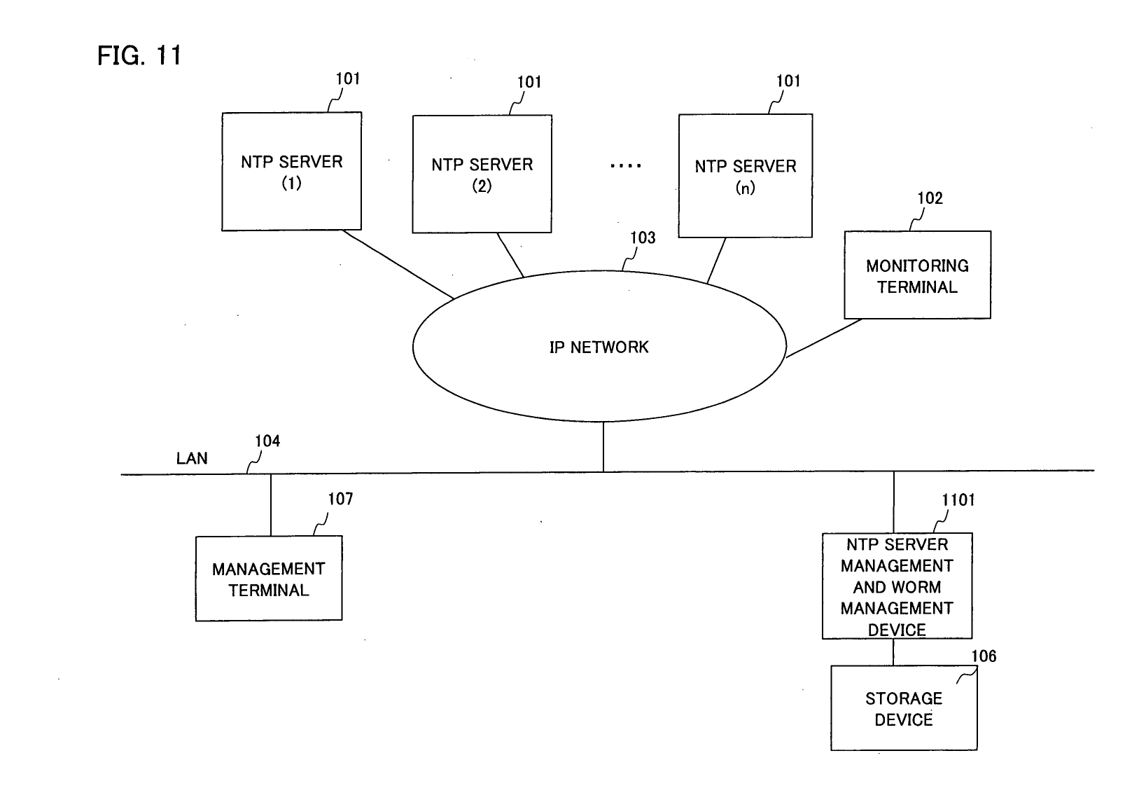

FIG. 11 is a block diagram of a storage system according to a second embodiment of the present invention.

The second embodiment differs from the first embodiment shown in FIG. 1 in that an NTP server management and WORM management device 1101 is provided. In the second embodiment, the same components as those of the first embodiment are not described in detail below.

The NTP servers 101 are computer devices each having a CPU, a memory, and an interface. The NTP servers 101 are hierarchically connected to other NTP servers (not shown) and refer to time information of an upper-level NTP server to correct their own time information. They are also connected to other terminals through the IP network 103 and provide their own time information in response to requests from the NTP server management and WORM management device 1101.

A monitoring terminal 102 is a computer device having a CPU, a memory, and an interface, on which a program for monitoring operating conditions of the NTP servers 101 is operating. The monitoring terminal 102 thus receives from the NTP server management and WORM management device 1101 a notification that some NTP server 101 has a trouble.

A management terminal 107 is a computer device having a CPU, a memory, and an interface, on which a program for setting, for example, which NTP servers 101 are to be referred to by the NTP server management and WORM management device 1101 is operating. The management terminal 107 is connected to the LAN 104. More specifically, when an administrator enters information for settings, such as IP addresses of NTP servers to be referred to by the NTP server management and WORM management device 1101 and times to perform the reference, then the management terminal 107 sets the information in the NTP server management and WORM management device 1101.

The NTP server management and WORM management device 1101 is a computer device having a CPU, a memory, and an interface and is connected to the storage device 106 and the LAN 104.

In the NTP server management and WORM management device 1101, a program for obtaining time information from the NTP servers 101 is operating. More specifically, the NTP server management and WORM management device 1101 obtains time information from a plurality of NTP servers 101 at a detachment check time and selects a most reliable NTP server 101, while detecting an NTP server 101 having a problem to notify the monitoring terminal 102 of the NTP server 101. Also, the time information is obtained from the most reliable NTP server 101 with given timing.

In the NTP server management and WORM management device 1101, a program for managing the retention periods of files stored in the storage device 106 is operating. The NTP server management and WORM management device 1101 determines whether or not to allow other terminals (not shown) connected to the LAN 104 to alter or delete the files on the basis of the time information obtained from the most reliable NTP server 101 by the program for obtaining time information from the NTP servers 101.

The storage device 106 is formed of, e.g. a disk array device, to and from which other terminals (not shown) connected to the LAN 104 write or read files.

1. A storage system, comprising:
a plurality of NTP servers that distribute time information;
a monitoring terminal that monitors operating conditions of the NTP servers;
a WORM management device that manages a retention period of data stored in a storage device;
an NTP server management device that obtains the time information from the NTP servers;
a management terminal that sets operating conditions of the NTP server management device; and
a network that connects the NTP servers, the monitoring terminal, the WORM management device, the NTP server management device, and the management terminal,
the NTP server management device comprising:
a first internal clock;
a time managing database in which priorities of the plurality of NTP servers are recorded;
an NTP client part that obtains the time information from the plurality of NTP servers;
a time detachment inspection part that makes a comparison between the plurality of time information obtained from the NTP servers and time information of the first internal clock;
a priority setting control part that changes the priorities of the NTP servers based on a result of the comparison made by the time detachment inspection part; and
a clock control part that obtains the time information from the NTP server having a highest priority, corrects the time information of the first internal clock based on the time information obtained, and notifies the WORM management device of the obtained time information,
the WORM management device comprising:
a second internal clock;
a WORM managing database in which the retention period of data recorded in the storage device is stored; and
a WORM file control part that corrects time information of the second internal clock based on the time information sent from the NTP server management device, refers to the WORM managing database to make a decision as to whether the retention period of the data recorded in the storage device ends after corrected time of the second internal clock, and prohibits alteration and deletion of the data depending on the decision.

2. A file management device which is connected to a storage device and to a plurality of NTP servers that distribute time information and manages a retention period of data stored in the storage device, comprising:
an internal clock;
a time managing database in which priorities of the plurality of NTP servers are recorded;
an NTP client part that obtains the time information from the plurality of NTP servers;
a time detachment inspection part that makes a comparison between the plurality of time information obtained from the NTP servers and time information of the internal clock;
a priority setting control part that changes the priorities of the NTP servers based on a result of the comparison made by the time detachment inspection part;
a clock control part that obtains the time information from the NTP server having a highest priority and corrects the time information of the internal clock based on the time information obtained;
a WORM managing database in which the retention period of data recorded in the storage device is stored; and
a WORM file control part that refers to the WORM managing database to make a decision as to whether the retention period of the data recorded in the storage device ends after corrected time of the internal clock, and prohibits alteration and deletion of the data depending on the decision.

3. A storage system, comprising:
a plurality of time servers that distribute time information;
a file management device that manages a retention period of data stored in a storage device; and
a time server management device that obtains the time information from the time servers,
the time server management device comprising:
a client part that obtains the time information from the plurality of time servers;
a time detachment inspection part that makes a comparison between the plurality of time information obtained from the time servers and given reference time information;
a priority setting control part that changes priorities of the time servers based on a result of the comparison made by the time detachment inspection part; and
a clock control part that obtains the time information from the time server having a highest priority, and notifies the file management device of the obtained time information,
the file management device comprising:
a first internal clock;
a file managing database in which the retention period of the data recorded in the storage device is stored; and
a file control part that corrects time information of the first internal clock based on the time information sent from the time server management device, refers to the file managing database to make a decision as to whether the retention period of the data recorded in the storage device ends after corrected time of the first internal clock, and prohibits alteration and deletion of the data depending on the decision.

4. The storage system according to claim 3, wherein the time server management device comprises a second internal clock,
the time detachment inspection part makes the comparison using time information of the second internal clock as the given reference time information, and
the clock control part corrects the time information of the second internal clock based on the time information obtained from the time server ranked highest in the priority order.

5. A file management device which is connected through a network to a plurality of time servers that distribute time information and manages a retention period of data stored in a storage device, comprising:
an internal clock;
a time client part that obtains the time information from the plurality of time servers;
a time detachment inspection part that makes a comparison between the plurality of time information obtained from the time servers and given reference time information;
a priority setting control part that changes priorities of the time servers based on a result of the comparison made by the time detachment inspection part;
a clock control part that obtains the time information from the time server having a highest priority, and corrects the time information of the internal clock based on the time information obtained;
a file managing database in which the retention period of the data recorded in the storage device is stored; and
a file control part that refers to the file managing database to make a decision as to whether the retention period of the data recorded in the storage device ends after corrected time of the internal clock, and prohibits alteration and deletion of the data depending on the decision.

6. The storage system according to claim 5, wherein the time detachment inspection part makes the comparison using the time information of the internal clock as the given reference time information.

7. A time server management device which is connected through a network to a plurality of time servers that distribute time information and to a file management device that manages a retention period of data stored in a storage device and obtains the time information from the time servers to notify the file management device of the obtained time information, the time server management device comprising:
a client part that obtains the time information from the plurality of time servers;
a time detachment inspection part that makes a comparison between the plurality of time information obtained from the time servers and given reference time information;
a priority setting control part that changes priorities of the time servers based on a result of the comparison made by the time detachment inspection part; and
a clock control part that obtains the time information from the time server having a highest priority, and notifies the file management device of the obtained time information.

8. The time server management device according to claim 7, further comprising an internal clock, wherein:
the time detachment inspection part makes the comparison using time information of the internal clock as the given reference time information; and
the clock control part corrects the time information of the internal clock based on the time information obtained from the time server having a highest priority.

9. A time information notification method for use in a storage system comprising a plurality of time servers that distribute time information, a file management device that manages a retention period of data stored in a storage device, and a time server management device that obtains the time information from the time servers,
the time information notification method comprising the following steps performed by the time server management device:
obtaining the time information from the plurality of time servers;
making a comparison between the plurality of time information obtained from the time servers and time information of a first internal clock;
changing priorities of the time servers based on a result of the comparison; and
obtaining the time information from the time server having a highest priority, correcting the time information of the first internal clock based on the time information obtained, and notifying the file management device of the obtained time information.

10. A data management method for use in a storage system comprising a plurality of time servers that distribute time information, a file management device that manages a retention period of data stored in a storage device, and a time server management device that obtains the time information from the time servers,
the data management method comprising the step of notifying the file management device of the time information by the time server management device in accordance with the method of claim 9;
the data management method further comprising the following steps performed by the file management device:
holding a file managing database that stores the retention period of the data recorded in the storage device;
correcting time information of a second internal clock based on the time information sent from the time server management device;
referring to the file managing database to make a decision as to whether the retention period of the data recorded in the storage device ends after the corrected time of the second internal clock; and
prohibiting alteration and deletion of the data depending on the decision.

11. A data management method for use in a file management device which is connected through a network to a plurality of time servers that distribute time information and manages a retention period of data stored in a storage device, comprising:
obtaining the time information from the plurality of time servers;
making a comparison between the plurality of time information obtained from the time servers and time information of an internal clock;
changing priorities of the time servers based on a result of the comparison;
obtaining the time information from the time server having a highest priority and correcting the time information of the internal clock based on the time information obtained;
holding a file managing database that stores the retention period of the data recorded in the storage device;
referring to the file managing database to make a decision as to whether the retention period of the data recorded in the storage device ends after the corrected time of the internal clock; and
prohibiting alteration and deletion of the data depending on the decision.
